(19) United States
(12) Patent Application Publication
(10) Pub. No.: US 2012/0223497 A1
(43) Pub. Date: Sep. 6, 2012

(54) Particulate Filled Wheel

(75) Inventors: Peter Radziszewski, Baie D'Urfe (CA); Sudarshan Martins, Montreal (CA)

(73) Assignee: The Royal Institution for the Advancement of Learning/McGill University

(21) Appl. No.: 13/037,431

(22) Filed: Mar. 1, 2011

(51) Int. Cl. B60B 37/00; B60C 7/06; B60C 7/00

(52) U.S. Cl. 280/80.1; 152/246

(57) ABSTRACT

Pneumatic tires made of a flexible elastomer material are well established for vehicles on paved roads. However, in many instances paved roads are in the minority, a rarity, or non-existent. Further many applications of motorized vehicles occur permanently off paved or unpaved surfaces where terrain is not solid but loose. Elsewhere compacted snow, very low temperatures, rocky environments, and mud present issues to pneumatic tires as does increasing vehicle weight which requires the load to be distributed across multiple wheels. It would be beneficial to have a tire that allowed for an expansion of the design space for tires that addresses the issues discussed above in a wide range of lunar and planetary environments with high load bearing. Such a tire is presented employing flexible particulate filled designs for improved drawbar pull, lateral resistance, hill climb potential, rolling resistance, and terrain accommodation.

### FIELD OF THE INVENTION

This invention relates to tires and more specifically particulate filled tires.

### BACKGROUND OF THE INVENTION

Today we know the tire (in American English and Canadian English) or tyre (in British English, Australian English and others) as a ring-shaped covering that fits around a wheel rim to protect it and enable improved vehicle performance by providing a flexible cushion that absorbs shock while keeping the wheel in close contact with the ground. However, it has not always been like this and the earliest tires were bands of iron (later steel), placed on wooden wheels, wherein the outer ring served to “tie” the wheel segments together for use, as well providing also a wear-resistant surface to the perimeter of the wheel. The first practical pneumatic tire was made by John Boyd Dunlop in 1887 for his son's bicycle, in an effort to prevent the headaches his son had while riding on rough roads.

Pneumatic tires are made of a flexible elastomer material, typically synthetic rubber or natural rubber, with reinforcing materials such as fabric and wire. Tire companies were first started in the early 20th century, and grew in tandem with the auto industry. Today, over 1 billion tires are produced annually; in over 400 tire factories, with the three top tire makers commanding a 60% global market share. They consist of a tread, which provides traction, and a body, which ensures support. The vast majority of these tires being used on the paved surfaces that form the roads and highways crossing countries and continents today, all approximately 18 million kilometers (or approximately 11.2 million miles) of them. However, not all applications are upon paved surfaces. In the United States, according to the Federal Highway Administration 2008 statistics, there were 2,734,102 miles of paved public roads, and 1,324,245 miles of unpaved public roads, of which only 46,036 miles are interstate highways and a total of 112,467 miles are part of the US national highway system.

Further in many parts of the world paved roads are in the minority, a rarity, or non-existent. Additionally, from the developed world to the under-developed world many applications of motorized vehicles occur permanently off of paved or even unpaved roads in applications such as farming, whilst in other areas of the world such as the sub-Sahara and Sahara the terrain is not solid but loose sand. Elsewhere across large portions of Europe, Russia, and Canada compacted snow, with or without very low temperatures, dominates the surface vehicles have to cope with. In other instances rocky environments or mud present issues to pneumatic tires as does increased vehicle weight which requires the load to be distributed across multiple wheels, for example semi-trailer trucks, also known as a semi, tractor-trailer, articulated truck, articulated lorry, or 18-wheeler, that consist of towing engine (tractor, truck), and a semi-trailer (plus possible additional trailers) that carry the freight and have 18 wheels with tires.

As a result, in many instances caterpillar tracks, also known as continuous tracks, are used. These provide a large surface area that distributes the weight of the vehicle better than steel or rubber tires on an equivalent vehicle, enabling a continuous tracked vehicle to traverse soft ground with less likelihood of becoming stuck due to sinking. Continuous tracks can be traced back as far as 1770 and today are commonly used on a variety of vehicles including bulldozers, excavators and tanks, but can be found on any vehicle used in an application that can benefit from the added traction, low ground pressure and durability inherent in continuous track propulsion systems. However, they suffer from much higher mechanical complexity and prolonged use place strain on the drive transmission and the mechanics of the continuous tracks, which must be overhauled or replaced regularly.

In extraterrestrial use additional challenges are presented to the designer of vehicular systems such as temperature. For example, rubber loses its elasticity at about −50° C. whereas the surface of the moon cycles between a mean daytime temperature of approximately 100° C. to a mean nighttime temperature of approximately −150° C. Likewise Mars has an average recorded temperature of −63° C. and a minimum of approximately −140° C. Accordingly, rubber tires with glass transition temperature of −70° C. would become brittle and shatter. Likewise rubber degrades when exposed to cosmic radiation. Additionally extraterrestrial locations may include no atmosphere, e.g. the moon, or low pressure, e.g. Mars with atmospheric pressure of 0.007 that of Earth, such that tires may be inflated with relatively low pressure but leading to substantial variations in effective inflation pressure with temperature even if the glass transition temperature is not reached.

Accordingly lunar and planetary mobility challenges will be surmounted by exploiting the knowledge of past mobility successes and failures, while expanding the design space from which an “optimal” design will emerge. Current mobility traction systems include walking systems, tracked systems, and wheeled systems. All of these systems are characterized by increased or decreased traction, efficiency and complexity. In the case of wheeled system designs for lunar mobility, these are limited to rigid or elastically compliant structures where compliance contributes to increased traction performance at the cost of increased complexity, see R. Bartlett et al in “Design of the Scarab Rover for Mobility and Drilling in the Lunar Cold Traps” (Intl. Sym. on Artificial Intelligence, Robotics and Automation in Space, February, 2008) for a review of the different approaches to movement in non-terrestrial environments.

Development of metal compliant wheels was initiated following the Kennedy challenge to go to the moon, see for example N. C. Costes et al in “Mobility Performance of the Lunar Roving Vehicle: Terrestrial Studies—Apollo 15 Results” (NASA Technical Report R-401), A. J. Green et al in “Performance of Boeing LRV Wheels in a Lunar Soil Simulant, Report 1, Effect of Wheel Design and Soil” (U.S. Army Engineers Waterway Experiment Station, Mobility and Environmental Division, M-71-10), and K-J Melzer et al in “Performance of Boeing LRV Wheels in a Lunar Soil Simulant, Report 2, Effects of Speed, Wheel Load, and Soil” (U.S. Army Engineers Waterway Experiment Station, Mobility and Environmental Division, M-71-10). Some of this development is illustrated in FIG. 1 by Grumman wheel A 110, Bendix wheel 120, and Grumman wheel B 130. These activities led to the development of the Apollo Lunar Rover Wheel 140. In a separate venture, the Soviet Union also designed a successful spoke wheel design, Lunokhod wheel 150. Subsequent work for the National Aeronautical and Space Administration (NASA) by Michelin led to the Tweel 160, which also inspired some reflection on a metal compliant wheel design. More recently, wheels in development by Michelin, Goodyear, Patel, and Genta have addressed alternative wheel structural designs to achieve elastic compliance, see for example J. Matson in “(Un)inflated Expectations: Airless Lunar Wheel Concept Gets a Workout on Moon Rover Prototypes” (Scientific American http://www.scientificamerican.com/slideshow.cfm? id=airless-tires-lunar-wheel&photo_id=170E554A-F622-37AF-5427DCEC90954461), A. Zerigui et al in “A Survey of Rover Control Systems” (Int'l J. Comp. Sci. & Eng. Sci., Vol. 1, No. 2, pp 105-110), and Carnegie Mellon University Press Release “Building Robot for Lunar Prospecting” (http://www.cmu.edu/news/archive/2007/September/sept20_scarab.shtml).

Considering Apollo Lunar Rover Wheel 140 this consisted of a spun aluminum hub and an 81.8 cm diameter, 23 cm wide tire made of zinc coated woven 0.083 cm diameter steel strands attached to the rim and discs of formed aluminum. Titanium chevrons covered 50% of the contact area to provide traction. Inside the tire was a 64.8 cm diameter bump stop frame to protect the hub. The Apollo Lunar Rover Wheel 140 was designed to solely operate on the relatively flat lunar surface with a lightweight load, two astronauts and some equipment, and not heavy loads on a wide range of surfaces.

It would be beneficial to have a tire that allowed for an expansion of the design space for tires that addresses the issues discussed above in a wide range of lunar and planetary environments with high load bearing. It would be further beneficial to provide tires for these environments that provided improved drawbar pull, power consumption, lateral resistance, hill climb potential, rolling resistance, rider comfort, road holding and terrain accommodation.

### SUMMARY OF THE INVENTION

It is an object of the present invention to obviate or mitigate at least one disadvantage of the prior art.

In accordance with an embodiment of the invention there is provided a device comprising a rim for mounting to an axle comprising an outer face and at each distal end an inner ring, a tire formed from at least a flexible material having a first edge demountably attached to the first inner ring and a second edge demountably attached to the second inner ring, and a plurality of particulates disposed within the tire.

In accordance with another embodiment of the invention there is provided a method comprising providing a vehicle comprising a chassis and an axle and providing a wheel mounted to the axle comprising a tire that is generally is compliant to the surface on which the vehicle sits.

In accordance with another embodiment of the invention there is provided a device comprising a rim, a tire formed at least in part by a flexible material demountably attached to the rim, and a plurality of particulates filling a predetermined portion of the tire.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts prior art configurations for tires for rugged terrains including non-terrestrial use;

FIG. 2 depicts the Canadian Space Agency JUNO rover and it's tires;

FIG. 3 depicts wheels with compliant tires and compliant hubs as well as a particulate filled tire according to an embodiment of the invention;

FIG. 4 depicts a tire according to an embodiment of the invention;

FIG. 5 depicts chainmail configurations for forming part of the outer compliant surface of tires according to embodiments of the invention;

FIG. 6A depicts a schematic of the structure of a tire and wheel hubs for tires according to embodiments of the invention;

FIG. 6B depicts a schematic of an alternate tire attachment means for tires according to an embodiment of the invention;

FIG. 7 depicts tires according to embodiments of the invention;

FIG. 8 depicts the critical velocity of vehicles fitted with tires according to embodiments of the invention with tire diameter as a function of gravity;

FIG. 9 depicts the drawbar pull load as a function of vehicle vertical load for tires according to embodiments of the invention as well as rubber and pneumatic tires;

FIG. 10 depicts drawbar pull load per unit width of the tires and power consumption as a function of vehicle vertical load;

FIG. 11 depicts power consumption versus velocity for tires according to embodiments of the invention and prior art rubber;

FIG. 12 depicts lateral loading slide versus vertical vehicle load for a tire according to an embodiment of the invention as well as maximum incline as function of vertical vehicle weight for tires according to an embodiment of the invention as well as pneumatic tires of the prior art; and

FIG. 13 depicts the vertical acceleration exerted on a vehicle fitted with prior art rubber tires and tires according to an embodiment of the invention.

### DETAILED DESCRIPTION

The present invention is directed to tires and more specifically particulate filled tires.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

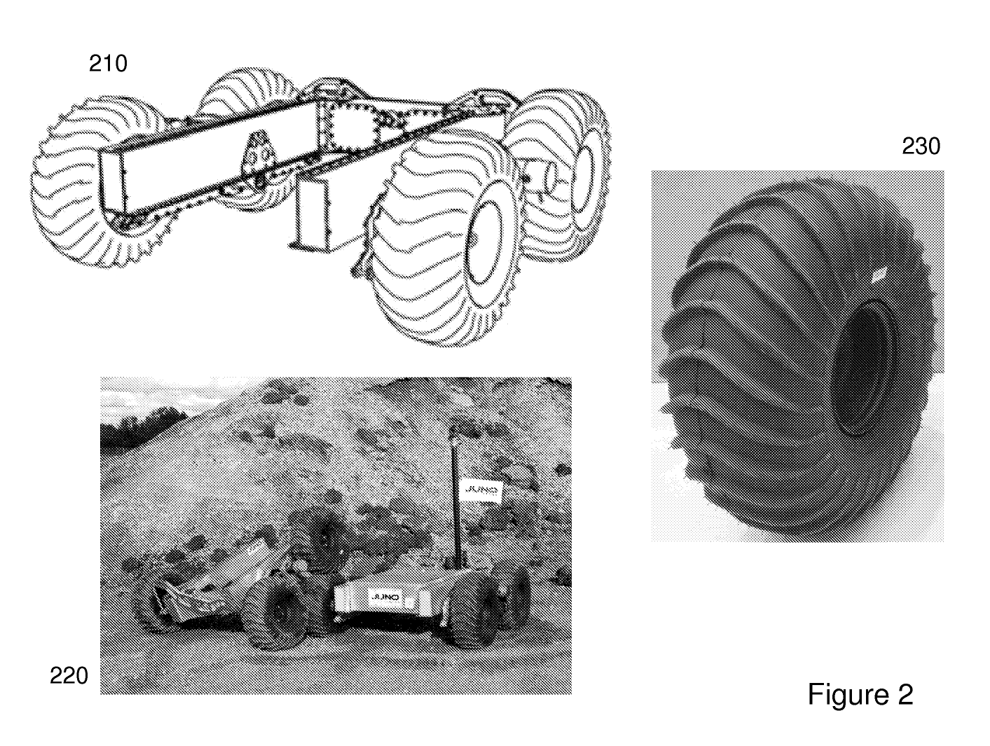

With the Canadian Space Agency initiated studies on the development of concepts, technologies and know-how in support of the development of lunar mobility systems, a study led by Neptec Design Group, aimed to investigate, conceptually design and test a lunar mobility system. These activities have led to the development of the JUNO rover 220 of FIG. 2. As shown by chassis schematic 210 in FIG. 2 the features of the JUNO rover are the lateral pair drive and control units, with skid steered directional control mounted to a U-shaped chassis via a walking beam suspension, system. The chassis configuration allowing increased modularity for accommodating various payloads. Also shown in FIG. 2 is pneumatic benchmark tire 230, being a tire 61 cm in diameter.

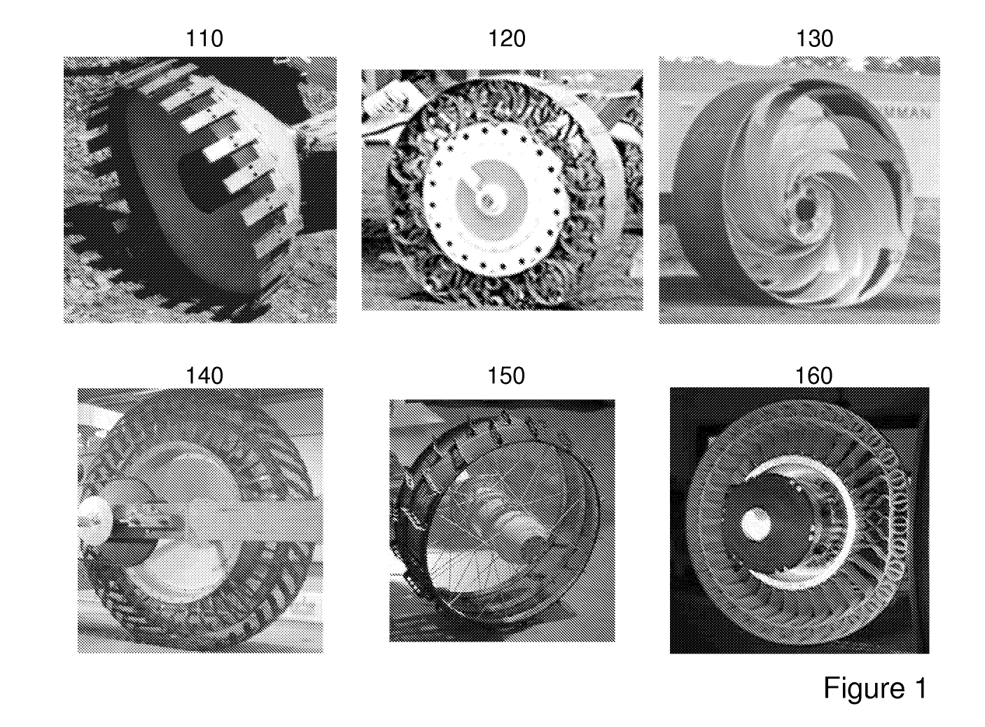

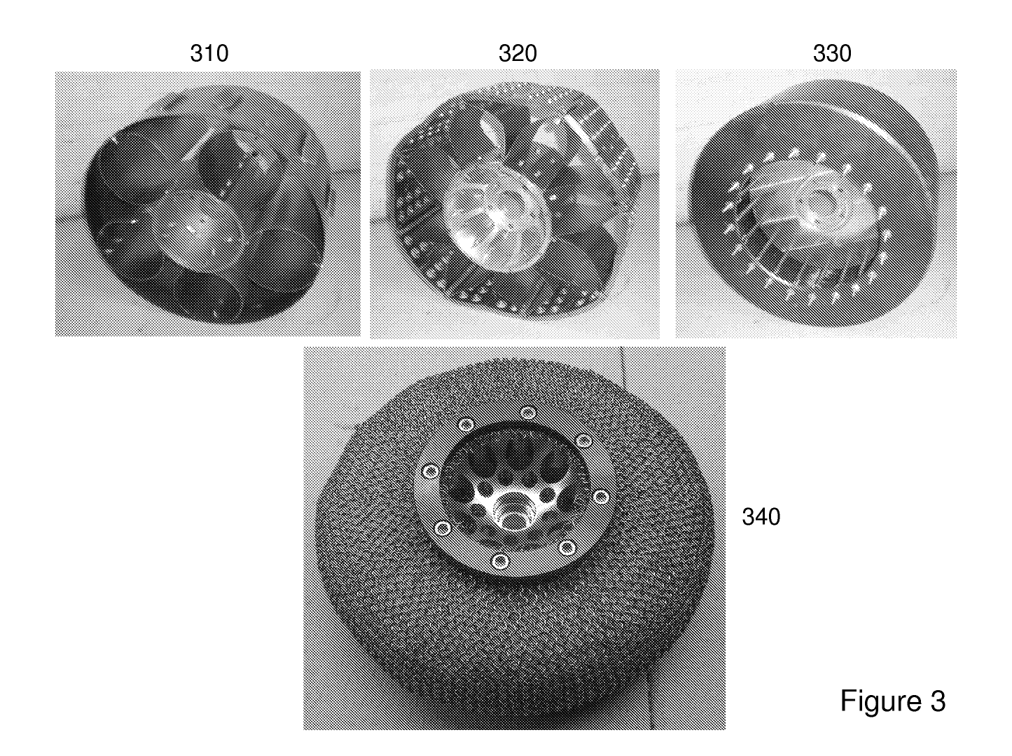

Referring to FIG. 3 there are depicted wheels with compliant tires and compliant hubs that form variants of the concepts initially considered in following the work described supra in respect of FIG. 1. First and second prototypes 310 and 320 respectively address the design and fabrication of the compliant wheel, while third prototype 330 addresses the concept of a design of a compliant hub. Each of the first to third prototypes 310 to 330 respectively being 22″ diameter. In examining these prototypes, it was found that all of them were characterized by elastic compliance. Plastic failure was the result of overloading the elastic designed capacity of a particular wheel concept. Referring back to the Apollo Lunar Rover Wheel 140 and the other era wheels depicted in FIG. 1 essentially define a class of wheels that are predominantly illustrated by elastic compliance.

All of these prior art wheel designs for lunar and planetary mobility systems have limited compliance as defined by wheel's elastic limits where plastic deformation usually leads to failure or sub-optimal wheel performance. The plastic limit is usually determined by the estimated maximum load on the wheel. The result is that for lighter than maximum loads, the wheels tend to behave as rigid or semi-rigid wheels. Rigid wheel performance reduces wheel traction on off-road applications by reducing the ground contact area typically seen in compliant rubber wheels, whereas semi-rigid wheels maintain ground contact to the limit defined by the elasticity/flexure of the structure. Further, these elastically deformable structures store any impact energy and then release it usually into the vehicle via a suspension system that dampens and dissipates the impact energy. This release of energy into the vehicle disturbs any payload through vibrations.

According to embodiments of the invention there is provided a wheel that can comply to off-road surfaces such as rocks and boulders. This compliance can be defined by the degree to which a tire surface conforms to the shape of a particular rock or boulder. The degree of conforming is determined inversely by the degree of rigidity of the fabric. In other words, a highly rigid tire will comply (or conform) poorly to a given surface shape while in a highly flexible (non-rigid) pliable tire will comply (or conform) very well to a given surface shape. Advantageously, such increased compliance with a highly flexible tire will increase the traction characteristics of such a tire on these given surfaces.

As will become evident from the descriptions below the invention provides a wheel that comprises a hub, a flexible fabric tire and a particulate filling. The hub can be rigid or flexible. The fabric tire can be selected from a wide range of materials including natural materials such as cotton, artificial woven fabrics such as polyester, and metals in the form of chainmail. The particulate filling can be any regularly shaped or irregularly shaped material that such as spheres, oblong objects, pebbles, stones, ceramic, etc. that is either manufactured or found naturally in the local environment. In one embodiment of the invention the wheel is composed of a hub, steel chainmail fabric tire and plastic balls as shown by prototype wheel 340 in FIG. 3.

Prototype wheel 340 comprising an aluminum beadlock hub to which a pliable stainless steel 4-in-1 chainmail 5″×1″ tire is attached. The tire is filled with 0.25″ diameter Delrin™ balls as the particulate filler. This prototype wheel was used on a small 4-wheeled rover vehicle on different terrain environments as well as some initial comparison tests. The initial results showed that a wheel according to an embodiment of the invention improved traction between 14% and 25% on the tested terrains as compared to a 5″×2.74″ rubber wheel. Vehicle drop tests indicate that drop energy is absorbed by the wheel rather than being communicated to the vehicle chassis etc. Further, initial test results of the vehicle driving over obstacles show that the stability of the vehicle increases.

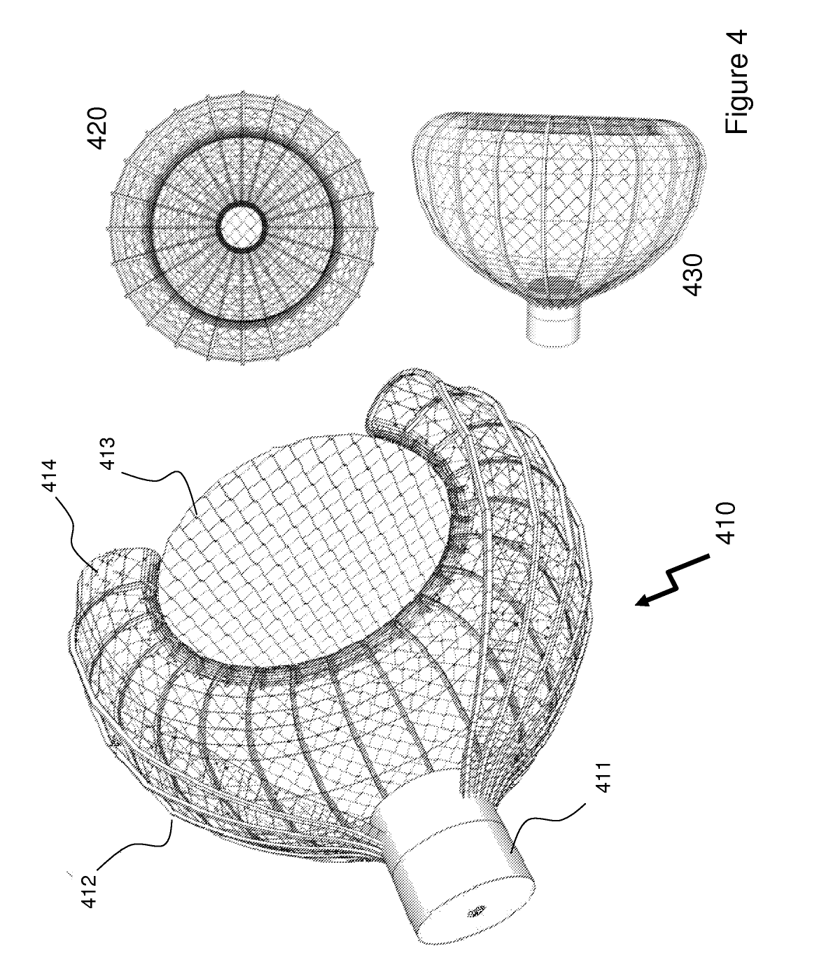

Referring to FIG. 4 there is shown a wheel 410 according to an embodiment of the invention. As shown the wheel 410 comprises a axle mount 411 attached to which are a plurality of grousers 412 that extend from the axle mount 411 and close back upon the axle mount. The grousers 412 may have links between them that join each grouser 412 to each adjacent grouser 412 thereby forming a very loose mesh. Within the plurality of grousers 412 there is disposed the tire that is formed from mesh material 414 around the periphery and hub material 413. Within the tire is the filler material, not shown for clarity.

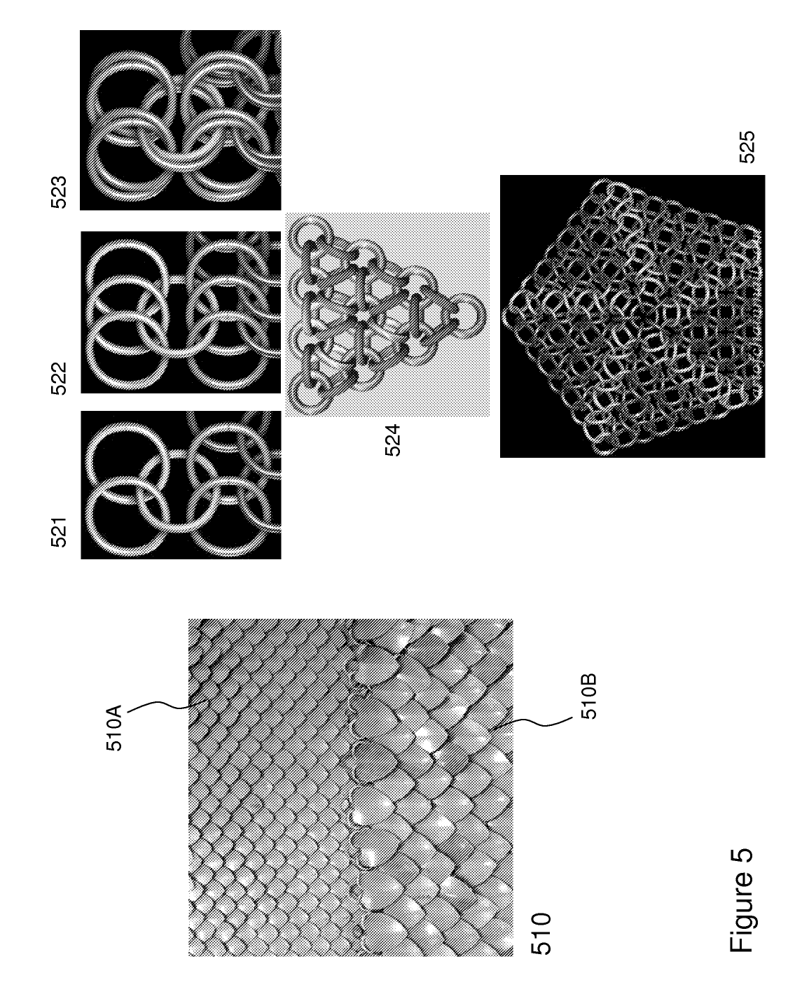

End elevation 420 and side elevation 430 show the wheel 410 as deployed wherein grousers can be clearly seen forming a series of rib like elements around the periphery of the wheel 410. The grousers 412 may be formed from solid structural rib like structures or alternatively from flexible chains. Referring to FIG. 5 there is shown the interface region between the mesh material 414 and hub material 413 wherein each are formed from first and second metal scales 510A and 510B respectively. In some embodiments of the invention these scales may provide increased traction characteristics in one direction whilst reducing it in the other direction for surfaces that are soft or granular.

Also shown in FIG. 5 are some chainmail configurations for forming part of the outer compliant surface of tires according to embodiments of the invention. First chainmail 521 being a European 4-in-1 chainmail wherein 4 rings at the apexes of a square are linked by a fifth ring in the middle of the square. Second chainmail 522 is a European 6-in-1 chainmail pattern whilst third chainmail 523 is European 9-in-1 chainmail, also referred to as King's Mail. Fourth chainmail 524 is also a 6-in-1 chainmail pattern like second chainmail 522 but is Japanese rather than European. Likewise fifth chainmail 525 is Japanese in origin and is known as Hana-Gusari mail being a 6-in-2 hexagon pattern, wherein such a chainmail design is one option for the hub material 413.

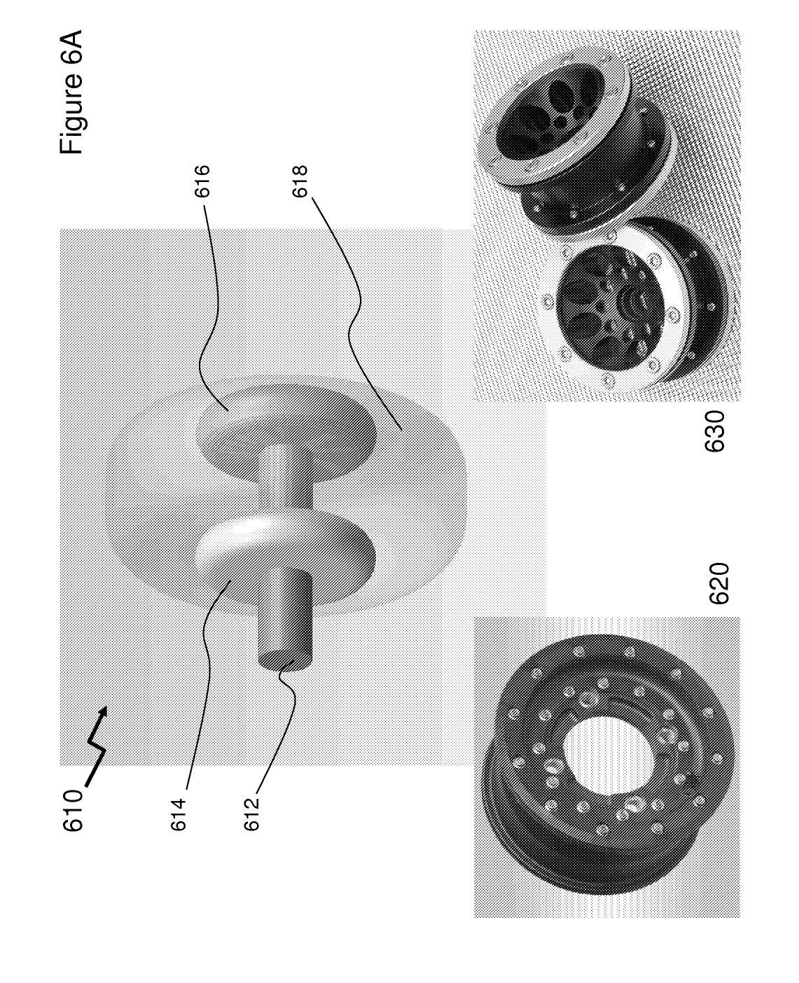

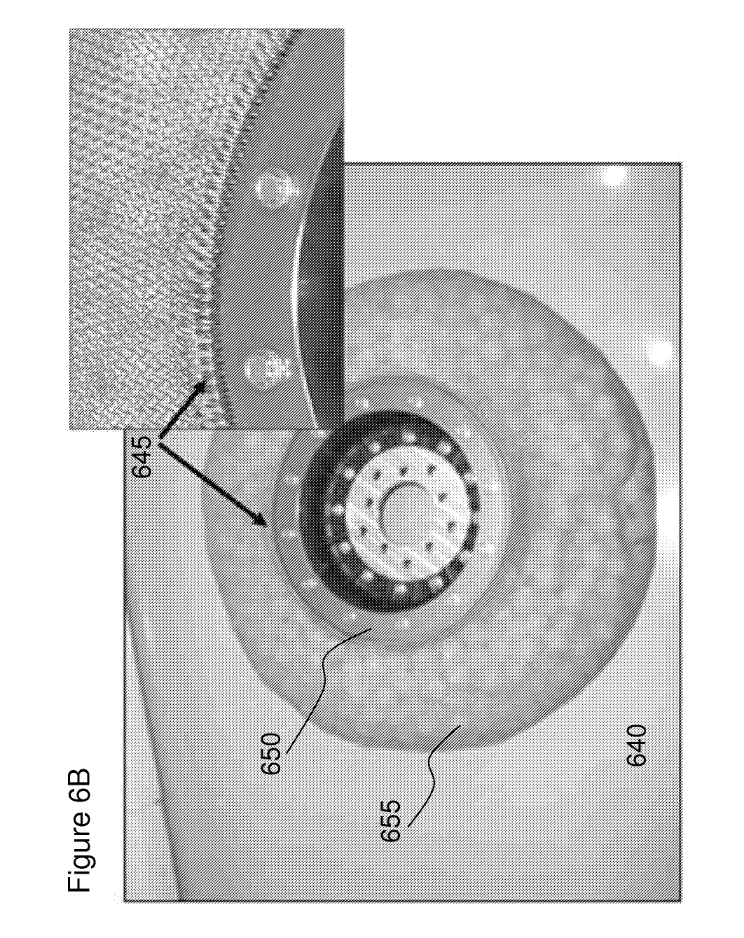

Now referring to FIG. 6A there is shown a schematic 610 of the structure of a tire and wheel hubs for a tire according to an embodiment of the invention. Accordingly there are shown axle 612, inner rim 614, outer rim 616 and the tire 618. The tire is a compliant material fashioned such that it has two side-walls, a nominal tread and a surface to which a rim can be attached. The material can be defined as any inter-connected flexible material, thin and engineered structure composed of natural, metallic, plastic or synthetic material and combinations thereof, and includes such items as wire mesh, Kevlar fabrics, Kapton foils and chainmail. The fabric can have a degree of structural elastic resistance to bending, but nominally would be quite pliable. The material selection as a tire material is determined by the requirements for such characteristics as tire strength, wear resistance and traction characteristics. The weave pitch of the materials should be smaller than the minimum size of the particulate filler. Typically, the material will be formed in such a way that it forms a tire of a given diameter and tire width. Typically, the inner diameter of the tire will be less than the outside diameter of the rim in designs such as that depicted in FIG. 6 providing sufficient overlap between the rim and the tire

The rim or inner and outer rims 614 and 616 respectively provide the interface with either a vehicle wheel hub or directly to a vehicle shaft. It also provides an interface between it and the fabric tire. This interface can be a mechanical connection such as a “beadlock” system typically found on off-road wheel rims as shown with first and second beadlocks 620 and 630 respectively, wherein each beadlock comprises a rim of cylindrical design having an outer surface and at each distal end a ring, commonly referred to as the inner ring, to which a plate, commonly referred to as the outer ring, is attached such that the tire is clamped between the inner ring and outer ring by means of an attachment means. A common attachment means being bolts that are disposed around the circumference. According to one variant the bolts form part of the inner ring and nuts are used to attach the outer ring, in another threaded inserts form part of the inner ring and bolts are threaded into them to clamp the outer ring to the inner ring, and in another nuts and bolts are inserted through holes in both the inner and outer rings. In other embodiments, dependent upon the properties of the material used to form the tire or that portion of the tire at the beadlock, other fitting may be employed that for example push-fit a protuberance from the outer ring into a recess in the inner ring or the outer ring may comprise a threaded portion to fit to a thread in the distal end of the rim. Irrespective of the particular mean of mating the inner ring and outer ring the intent is to clamp the material of the tire between them and therein to the rim, and hence physically attach the tire as part of the wheel.

Referring to FIG. 6B there is depicted an alternate tire attachment according to an embodiment of the invention in schematic 640 comprising particulate filled tire 655 and rim 650 that mounts to an axle, not shown for clarity. The edge of the particulate filled tire 655 intended to fit the rim 650 is fitted with a spring 645 such that when fitted the spring 645 pulls the edge of the particulate filled tire 655 down against the rim 650.

The particulate filler can be any particulate that is free-flowing and that can support the weight of the vehicle as well as the associated impact of off-road mobility. For example, the filler in a lunar mobility application could be lunar regolith screened to a desired size distribution or processed to produce regolith rounded pebbles. The minimum size of the particulate is determined by both the material characteristics of the particulate and the desired flow characteristics within the tire. However, a space rated abrasive resistant plastic such as polyoxymethylene or polyether ether ketone, for example, can also be used. In a terrestrial application, one could also consider the use of readily available rubber, plastic balls or screened rock pebbles, steel balls and ceramics for example.

The assembly of particulate filled fabric wheel requires that the tire and rim provide the possibility to fit the rim inside the tire. This will require that one of the tire side walls has an opening to allow the rim to be slipped inside. Alternatively, the rim can be fashioned such that the tire can be more easily placed onto or off the rim. Once the rim is inside the tire, the open side of the tire is attached to the rim. With a beadlock rim, such as presented supra in FIG. 6, this translates to screwing the beadlock ring to the rim. The screws/bolts/or other attachment devices used may have to pass through the material. On the open side of the fabric, the opening may be stitched back together or some other joining mechanism such as a zipper employed. Once the opening is closed, the particulate can be poured into the tire. The particulate filling can be up to 100% of the tire inside volume that would provide for a rigid wheel. Typically, tire particulate filling would be less than 100% and would be dependent on the desired ground contact area of the tire and the amount of shock absorbing capability the tire would require.

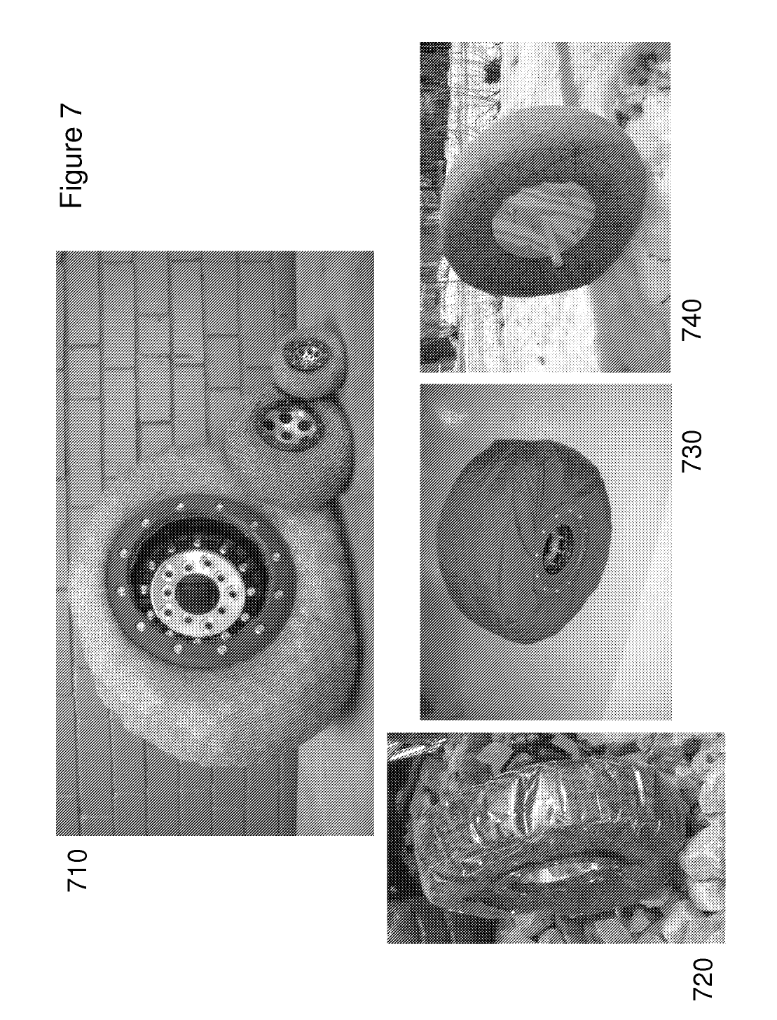

Referring to FIG. 7 there are shown functional tires built according to embodiments of the invention. Referring to optical micrograph 710 there are shown first to third tires assembled according to embodiments of the invention. Each of these tires uses a chainmail tire, this wheel concept is referred to subsequently as the “iRing” wheel. Initial results illustrate that for a 12.7 cm (5″) diameter wheel increased traction (on a per unit width basis) can be achieved albeit at the expense of an increased energy consumption during locomotion, as will be shown below. However, the wheel also holds the promise of increased damping, potentially allows for increased vehicle speed on the lunar surface and/or simplification of the vehicle suspension design. Subsequently 20.3 cm (8″) and 55.9 cm (22″) diameter iRing wheels were manufactured performance characterization.

Fourth tire 720 is a 5″×1″ prototype comprising an aluminum beadlock hub to which a fairly pliable felt fabric tire is attached and is filled with 0.25″ diameter dried peas as the particulate filler. This prototype was used to test the compliant nature of the wheels on a small 4-wheeled rover and a rock terrain. The results indicated that the particulate wheel worked in a mobility application. Fifth tire 730 shows a 22″×10″ working prototype that comprises of three elements: a composite material beadlock hub to which a fairly pliable heavy duty synthetic fabric tire has been attached and is filled with 1″ diameter wood ball particulate filler. This prototype illustrates that the particulate wheel concept is scalable. Further, this prototype used a split opening on the circumference of the tire as a means to position the rim inside the tire. The split opening was then tied closed once the particulate was introduced. Sixth tire 740 shows a functional mock-up comprised of a plywood hub to which a pliable cotton fabric bean bag is attached and is filled with Styrofoam™ bean particulate.

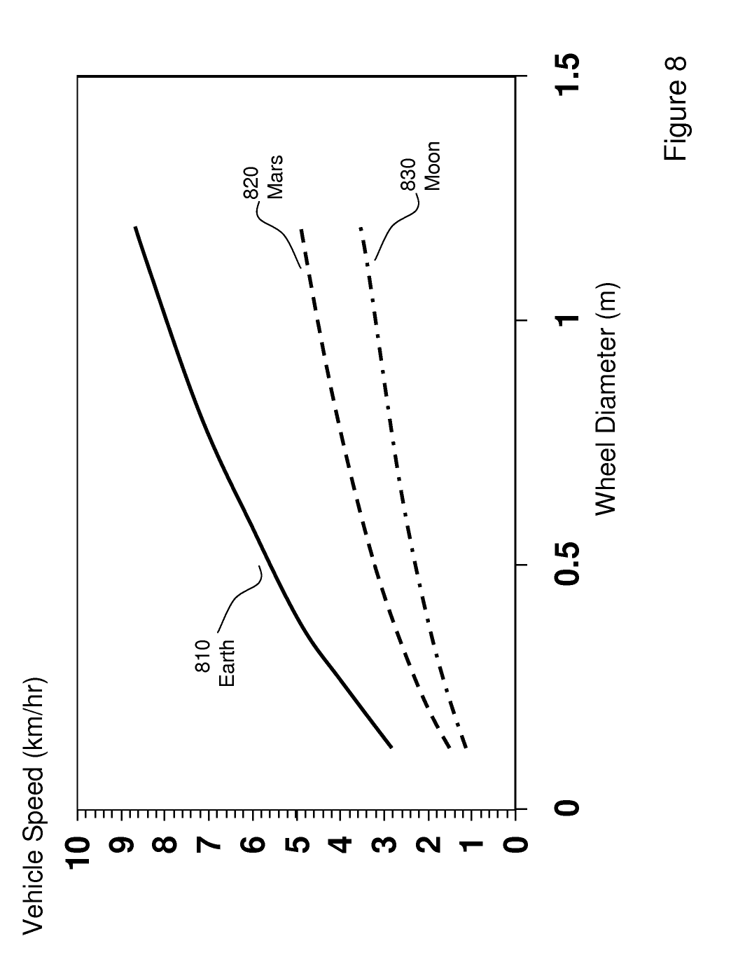

Referring to FIG. 8 there is depicted a graph showing the velocity of vehicles fitted with tires according to embodiments of the invention with tire diameter as a function of gravity. It would be evident to one skilled in the art that this wheel concept is characterized by the granular flow of the particulate fill contained between a hub and a flexible, chainmail in the case of the iRing, tire. The particulate can be any pebble like material such as ceramic or plastic balls. Ultimately, the particulate can be potentially screened regolith pebbles or sintered/molded regolith beads in non-terrestrial applications. The modeling of the wheel is similar to that of tumbling mills, typically found in the mining industry, wherein the mill charge, composed of rocks and grinding media, is continually lifted in a rotating drum. This behavior is similar to the expected dynamics of the particulates in wheels according to embodiments of the invention. Just as in the case of the tumbling mill, the particulates will centrifuge at a specific rotation speed, which is a function of the wheel radius and the gravitational pull. This rotation speed, in mineral processing, is called the critical speed (ω_{c}[rad/s]) and is defined by Equation (1).

$$ω = \sqrt{\frac{g}{R - r}} \qquad ( 1 )$$

where g is the gravitational acceleration, and R is the radius of the wheel.

For a particulate filled wheel concept, according to embodiments of the invention, it is possible to modify this equation such that the critical speed can be expressed as the vehicle speed, v km/hr, at which centrifuging occurs, Equation (2):

$$v = 3.6 \sqrt{\frac{Dg}{2}} \qquad ( 2 )$$

where D is the diameter of the wheel in meters.

For a 12.7 cm (5″) diameter wheel, the critical speed on earth would be just under 3 km/hr, while on the moon this wheel would centrifuge at just over 1 km/hr. This critical speed is significant because it can be used to describe two mobility regimes for such a wheel. Below this critical speed, one would expect a larger ground contact area and therefore greater traction. This would be typical of slower mobility application such as grading and pulling loads as well as climbing slopes. Above this speed, a particulate-filled chainmail wheel would be expected to stiffen with increased speed, due to the increased centrifugal forces exerted by the particulate. One can speculate that at greater speeds, this stiffening will lead to a wheel behavior closer to a rigid wheel. In this regime, the wheel would presumably exhibit a decreased rolling resistance, rendering it more efficient, with increased speeds mainly because the ground contact area will decrease. However, in a breaking situation, one can speculate that the charge would fall into the first regime, a loose system that will quickly increase the ground contact area and therefore increase the stopping force in braking.

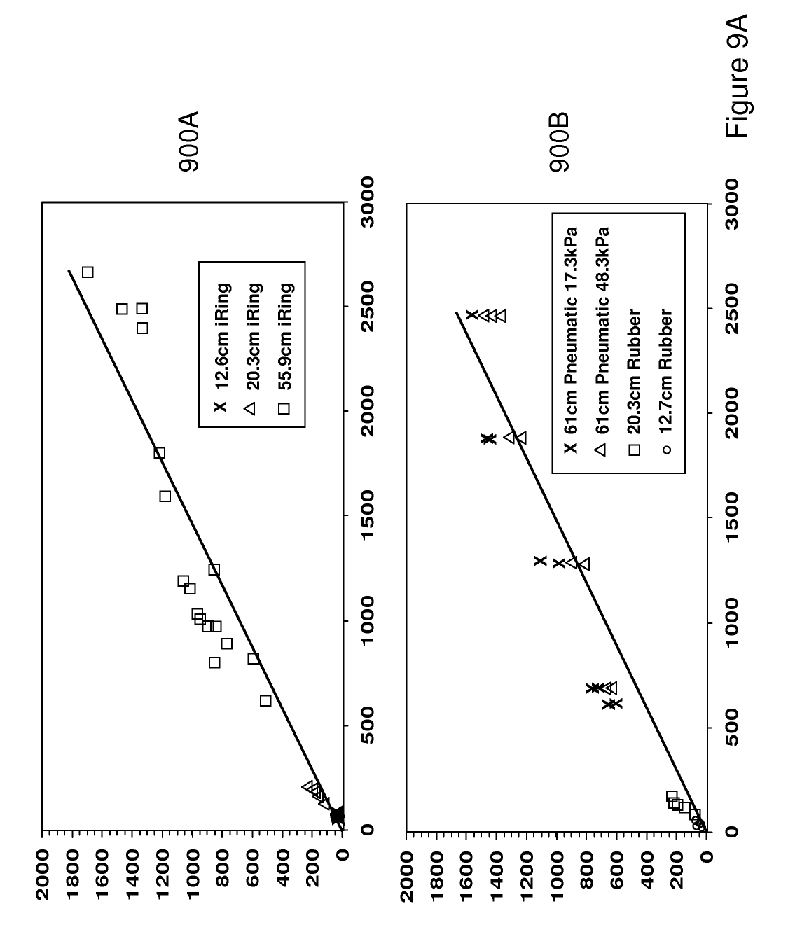

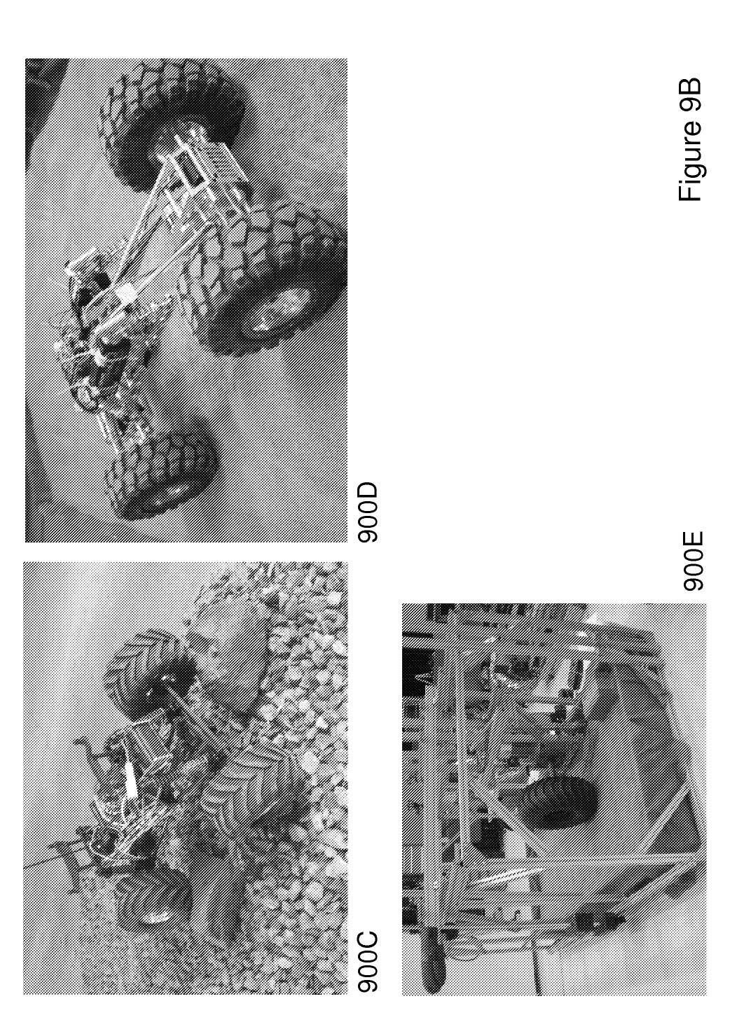

Now referring to FIG. 9 there are depict first and second graphs 900A and 900B wherein the drawbar pull load as a function of vehicle vertical load for tires according to embodiments of the invention as well as rubber and pneumatic tires. Traction for all wheels prototypes was measured at 100% slip using a load cell, wherein slip is the difference between the tangential speed of the wheel as determined from wheel rotation speed and radius of the wheel and the actual speed of the vehicle. In the case of the 12.7 cm (5″) and the 20.3 cm (8″) diameter wheels, the load cell was connected to a 4-wheeled rover design, shown in FIG. 9B by first and second rovers 900C and 900D respectively. These were driven forward and the maximum drawbar pull was recorded. The drawbar pull is the metric typically used are to describe the traction capabilities of mobility systems in deformable soils. In the case of the 55.9 cm (22″) wheels, a single wheel tested, see tested 900E in FIG. 9B, was used and the results, both traction and load, were multiplied by 4 to provide a similar comparison with the 4-wheeled rover results. The aggregate traction results can be found in first schematic 900A for the iRing concept wherein a linear relationship between drawbar pull (DBP), F_{DBP}, and applied vertical load (Total Rover Load), F_{RLoad}, can be seen for the various iRings wheels. This results in drawbar pull to weight ratio described by the relationship F_{DBP}=0.6845F_{RLoad}.

Second schematic 900B depicts the results of the same tests for pneumatic rubber tires according to the prior art. In the case of the 61 cm (24″) diameter rubber wheels, the tests were completed with tire pressures of 48.3 kPa (7 psi) and 17.3 kPa (2.5 psi) to determine the effect of tire pressure as well as with 12.7 cm (5″) and 20.3 cm (8″) tires. A linear estimate of the correlation found between draw bar pull (F_{DBP}) to load (F_{RLoad}) was F_{DBP}=0.7177F_{RLoad}. As such the linear coefficient is slightly larger for the rubber tires than the iRing tires according to embodiments of the invention.

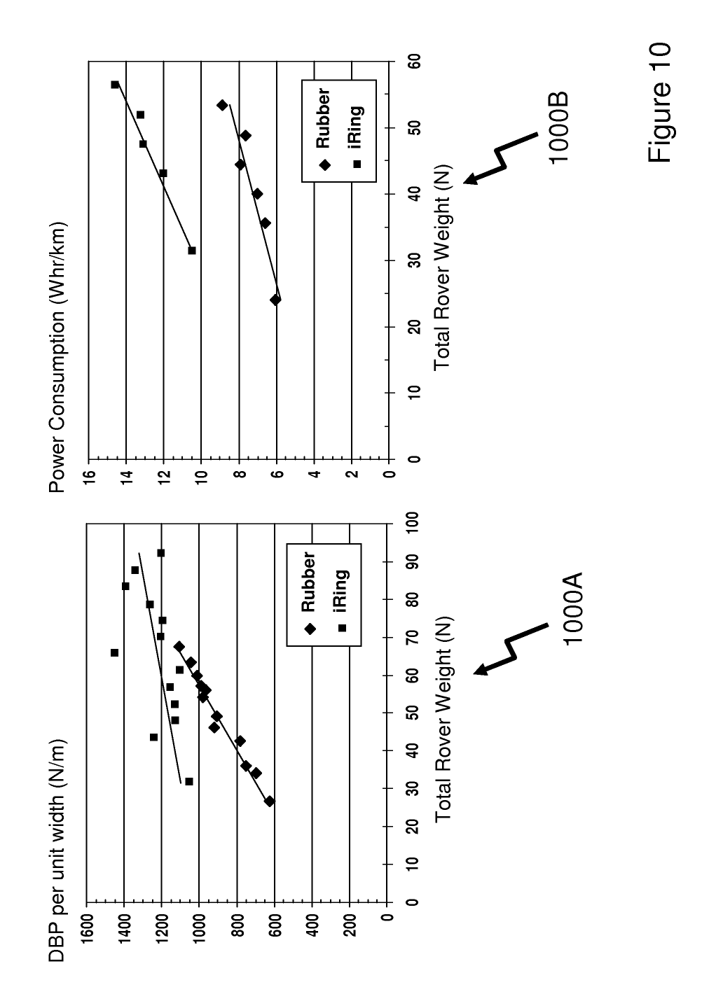

Referring to FIG. 10 there is shown first plot 1000A wherein the DBP for the iRing and rubber tires is plotted as a function of unit width as the rubber tire effective tread widths were approximately double the effective tread width of the iRing. As is evident from first plot 1000A the traction of the iRing wheels was greater per unit contact area than the rubber wheel benchmark. It should be noted that the wheel concept according to embodiments of the invention dissipates energy as opposed to storing it and releasing it in an elastically compliant structure, and as such it can be expected that the rolling resistance of this wheel would be greater than the benchmark rubber wheel. To this end, a number of tests were completed to determine and compare the energy consumed by the rover tested with the rubber benchmark wheel and the iRings wheel as a function of load resulting in second plot 1000B. At 1 km/hr (0.3 m/s), the draw bar pull increased with load as expected in both wheel cases. However, it is clear that for the iRing wheel the power consumed is greater than that consumed by the rubber wheel. These tests being completed on a 12.7 cm (5″) wheel at a speed less than the critical speed of just less than 3 km/hr. As noted above as the speed increases the wheel stiffens and as such it is anticipated that at higher speeds the wheel power consumption would improve.

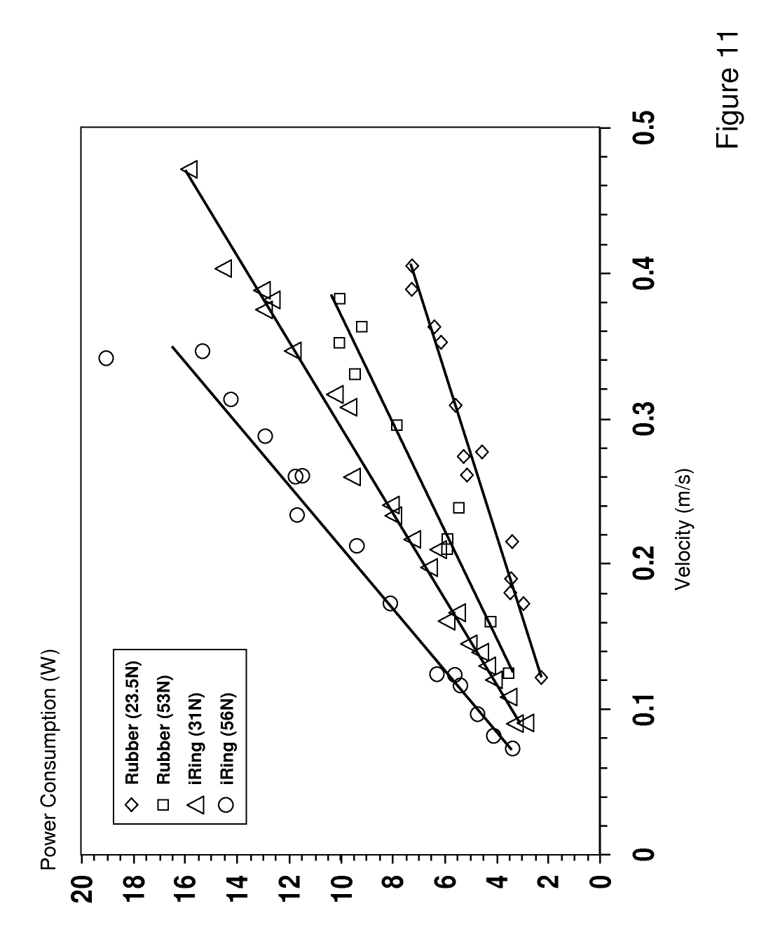

Typically, the power consumed, P_{rolling}, for a given vehicle is a measure of the power train efficiency of that vehicle which can be expressed as a unit of power over a unit of vehicle speed. In the case where the power train is maintained as a constant and only the wheels are being changed, the resulting power consumption can be used as a measure of the impact of the wheels on rolling efficiency. As such, rover power consumption during motion was measured for the 12.7 cm (5″) and the 55.9 cm (22″) diameter iRing wheels according to embodiments of the invention and for 12.7 cm (5″) and 61 cm (24″) diameter rubber wheels. For the 12.7 cm diameter wheels, the rover power consumption was measured at varying speeds and loads. The results for these tests being shown in FIG. 11 wherein it is possible to see that the iRing wheels consume more power with increase load than the rubber bench mark wheel. The increase in power consumed for similar loads is almost twice that of the rubber wheel benchmark. Similar results were obtained for the 55.9 cm (22″) diameter iRing and 61 cm (24″) diameter rubber wheels.

Typically the lateral resistance of a vehicle on soft soil is a function of the stiffness of the wheels used as well as the resistance to sliding. The stiffness of the wheels in the lateral direction provides an indication of much a wheel will deflect before sliding commences while resistance to sliding is defined by the wheel/soil interface. Lateral stiffness tests were performed using the same load cell used for traction tests whilst deflection was measured using a vernier caliper. The lateral stiffness of the iRing wheels was determined to be 53.8N/mm while for the rubber benchmark wheels the lateral stiffness was determined to be 6.4N/mm This indicates that the iRing wheels is significantly stiffer in the lateral direction than the rubber benchmark wheel.

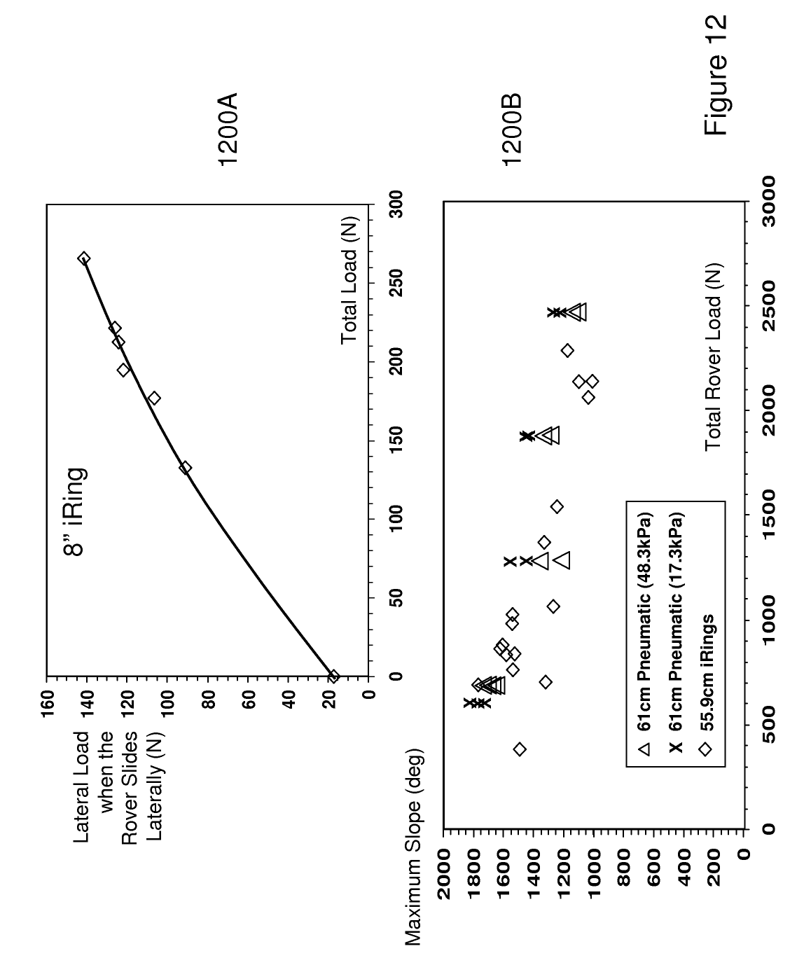

The measurement of resistance to lateral sliding is similar to the measure of draw bar pull in that it is a measure of the resistance of the wheel/soil interface to movement that can be used to estimate the slope that a wheel can hold in the lateral direction. The lateral sliding test was performed only with the iRing wheels according to embodiments of the invention. These tests were conducted using the same load cell used for draw bar pull measurements and were limited to testing the 20.3 cm (8″) wheels alone. It should be noted that the rover test bed vehicle was pulled laterally from the center of the vehicle. Referring to first graph 1200A in FIG. 12 it can be seen that the lateral resistance to sliding was found to increase with increased load. It is interesting to note that the lateral resistance for these wheels is approximately half the draw bar pull. Making the observation that in the case of the draw bar pull, the length of the ground contact patch of a wheel has a greater effect on traction than the width of the wheel, one could expect that lateral resistance to sliding could be increased by increasing the width of a given set of wheels.

In addition to simply pulling loads it is important that vehicles in terrestrial and non-terrestrial are able to do so on inclined plane, i.e. slopes. This can be estimated from Equation (3) below that relates the rover load, F_{RLoadi}, to the draw bar pull force, F_{DBPi}, through an effective friction coefficient, μᵢ, which describes the maximum slope, θᵢ, that a body can hold without sliding.

F_{DBPi}=μᵢF_{RLoadi} (3)

where μᵢ=tan(θᵢ).

Using this relationship, it is possible to use the previous draw bar pull results to estimate the potential critical slope angles. However, according to Freitag et al in “Wheels for Lunar Wheels” (J. Terramechanics, 8(3), pp 89-105), the actual slope climbing performance was found to be about 3 degrees less than the estimate determined by Equation (3). Therefore, the maximum slope angle that can be climbed based on the draw bar pull results is θ_{max i}=θᵢ−3. Accordingly, second plot 1200B in FIG. 12 displays the resulting maximum slopes for the 61 cm (24″) diameter pneumatic wheels at both the 48.3 kPa and 17.3 kPa inflation pressures alongside the 55.9 cm (22″) diameter iRing wheel. From this graph, it is fairly clear that the lower pressure pneumatic wheel tends to provide the best potential slope climb angle. However, the iRing wheel, which is only 15 cm (6″) wide compares quite well with the pneumatic wheels, which were 25.4 cm (10″) wide.

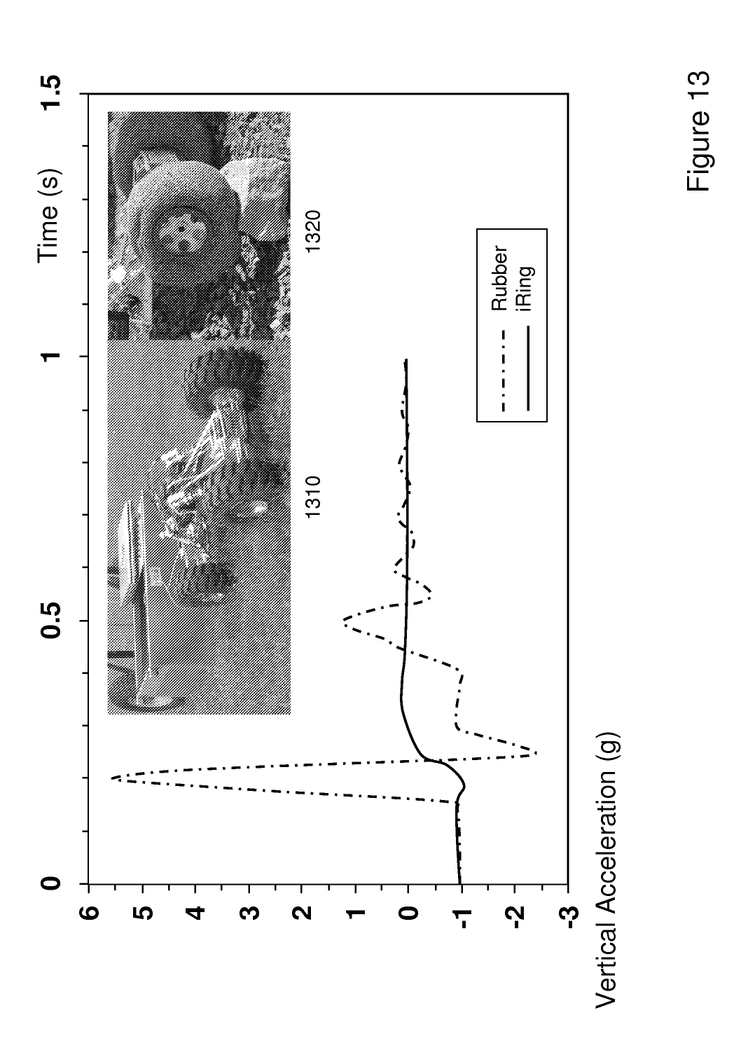

Any mechanical system can be characterized by its stiffness and damping. In the case of a wheel, such information can be used to design and size a vehicle suspension system. In the present case, a single axis accelerometer was fixed to the drive axle connecting the rear wheel pair to measure the body fixed reference vertical acceleration of the unsprung mass, which is, neglecting the sprung suspension of the chassis. The accelerometer was connected to a data acquisition system, as shown in first insert 1310 in FIG. 13.

In order to characterize the stiffness and damping coefficients of the rubber and iRings wheel, a drop test was conducted to record the vertical acceleration response of the unsprung mass. The collected data is representative of the response of the wheel since the accelerometer is mounted directly to the drive axle. A sample drop test of both the rubber and iRing wheel measurements collected is shown by the graph in FIG. 13. It can be seen that after the fall (−1 g acceleration), the chassis experiences some impact forces and some bouncing. The magnitude of the impact forces and bouncing is a function of the wheel used. In the case of the rubber wheels, it can be seen that after the initial impact the rover bounces, resulting in another freefall as indicated by the horizontal section of the graph. The bouncing continued until the rover eventually stood still and the tires absorbed the remaining potential energy. In the case of the iRing wheel, the initial bounce results in a much lower peak acceleration due to the high shock absorbing capabilities of the particulate filled tires. The rover settles quicker than the rubber wheel, with only slight overshoot in acceleration. This signifies that the iRing wheel has a much higher damping effect than regular rubber wheels, a property typically not exhibited in elastically compliant wheels unless significant material hysteresis is present.

From the drop tests, the stiffness and damping coefficients of the wheels can be estimated by simplifying each wheel for the purposes of modeling as a linear spring mass damper system. Without an external force, the general equation for an unforced spring-damper system is given by:

m\ddot{x}=−c\dot{x}−kx (4)

where x is the position, m is the mass, c is the damping coefficient and k is the spring constant. A simple rearrangement of the equation provides the equivalent equation:

\ddot{x}+2ζωₒ\dot{x}+ωₒ²x=0 (5)

where the natural frequency of the system, ωₒ is given by:

ωₒ=\sqrt{k/m} (6)

and the damping ratio, ζ, is:

$$ζ = \frac{c}{2 \sqrt{km}} \qquad ( 7 )$$

Here, a classification of spring-damper systems can be made. If the damping ratio is less than 1, then is system is under-damped. It will oscillate when stimulated. If the damping ratio is greater than 1, it will slowly return to equilibrium when stimulated. With a damping ratio equal to 1, the system is critically damped. When stimulated, such a system returns to equilibrium faster than over-damped systems, and does so without any oscillation. The solution to the spring-damper system is:

x(t)=Ae^{ωt} (8)

In the under-damped case, ω is:

w=−ζωₒ+iωₒ\sqrt{(1−ζ²)} (9)

The second derivative of the solution is:

x̅(t)=Aω²e^{ωt}=ω²x(t) (10)

Therefore, functionally, the acceleration takes the same form as the position.

ƒ(t)=e^{-ζω}^{ₒ}^{t}└B cos(ωₒ\sqrt{(1−ζ²)}t)+C sin(ωₒ\sqrt{(1−ζ²)}t)┘ (11)

Fitting these relationships to the accelerometer results allows the resonant frequency and the damping ratio to be determined. The results of the rubber and iRing drop test, both on concrete and sand, are tabulated below in Table 1. The drop tests were completed with the 20.3 cm diameter wheeled rover. In the case of the rubber wheel the unforced spring-damper analogy can be applied after 0.5 s where the rover continues vibrate as it relaxes. The damping ratio of the iRing is much greater than for the rubber wheel, this stemming from the particulate nature of the wheel.

TABLE 1
Drop Test Results—Natural Frequency and Stiffness Coefficients

| Surface | Wheel Type | Natural Frequency (Hz) ωₒ = \sqrt{k/m} | Damping Ratio $ζ = \frac{c}{2 \sqrt{mk}}$ | Mass (kg) | Stiffness (kN/m) |
|---|---|---|---|---|---|
| Sand | Rubber | 41.0937 | 0.2116 | 0.91 | 1.5367 |
| | iRing | 39.7002 | 0.6766 | 3.62 | 5.7055 |
| Concrete | Rubber | 42.9407 | 0.1328 | 0.91 | 1.6780 |
| | iRing | 35.8035 | 0.5386 | 3.62 | 4.6404 |

Wheel terrain compliance was evaluated qualitatively through experimental testing on lunar analogue terrain. In second inset 1320 of FIG. 13 a 20.3 cm (8″) diameter wheel is pictured resting on a rock edge. It is possible to see how the iRing wheels conform to rock surfaces with low wheel loading thereby providing increased contact between the iRing wheel and the rock surface.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A device comprising:
a rim for mounting to an axle comprising an outer face and at each distal end an inner ring;
a tire formed from at least a flexible material having a first edge demountably attached to the first inner ring and a second edge demountably attached to the second inner ring; and
a plurality of particulates disposed within the tire.

2. The device according to claim 1 further comprising;
a first outer ring for attachment to the first inner ring;
a second outer ring for attachment to the second inner ring; wherein
the first edge of the tire is clamped between the first outer ring and the first inner ring and the second edge of the tire is clamped between the second outer ring and second inner ring.

3. The method according to claim 1 wherein,
at least one of the first edge and second edge further comprise a spring attached to the flexible material of the tire.

4. A device according to claim 1 wherein,
at least one of the rigidity of the device varies in dependence upon at least the rotation speed of the device and the tire generally conforms to the terrain thereby increasing the area of ground contact.

5. A device according to claim 1 wherein,
a predetermined portion of the flexible material is at least one of a chainmail and a fabric; and
the plurality of particulates are graded with a minimum dimension greater than a predetermined minimum dimension established in dependence upon a characteristic of the flexible material.

6. A device according to claim 1 further comprising;
a plurality of grousers disposed upon the outer surface of the tire.

7. A method comprising:
providing a vehicle comprising a chassis and an axle;
providing a wheel mounted to the axle comprising a tire that is generally is compliant to the surface on which the vehicle sits.

8. The method according to claim 7 wherein,
the tire is formed from at least a flexible material and a plurality of particulates disposed within the tire

9. The method according to claim 7 further comprising;
a rim for mounting to the axle comprising an outer face and at each distal end an inner ring; wherein,
a first edge of the tire is for demountably attaching to the first inner ring, and
a second edge of the tire is for demountably attaching to the second inner ring

10. The method according to claim 7 wherein,
the rigidity of the device varies in dependence upon at least the speed of the vehicle.

11. The method according to claim 7 wherein,
a predetermined portion of the flexible material is at least one of a chainmail and a fabric; and
the plurality of particulates are graded with a minimum dimension greater than a predetermined minimum dimension established in dependence upon a characteristic of the flexible material.

12. A device according to claim 7 further comprising;
a plurality of grousers disposed upon the outer surface of the tire.

13. A device comprising:
a rim;
a tire formed at least in part by a flexible material demountably attached to the rim; and
a plurality of particulates filling a predetermined portion of the tire.

14. The device according to claim 13 wherein;
at least of a characteristic of the tire varies in dependence upon at least the rotational rate of the tire and the device generally conforms to the surface upon which the device sits.

15. The device according to claim 13 wherein;
the flexible material is formed at least in part from at least one of a chainmail and a fabric; and
the plurality of particulates are graded with a minimum dimension determined in dependence upon a characteristic of the flexible material.

16. The device according to claim 13 wherein;
the tire has a single opening.

17. The device according to claim 16 wherein,
the edge of the single opening comprises a spring attached to the flexible material of the tire.

18. The method according to claim 13 further comprising;
a plurality of grousers disposed upon the outer surface of the tire.
